(19) United States
(12) Patent Application Publication
(10) Pub. No.: US 2011/0184621 A1
(43) Pub. Date: Jul. 28, 2011

(54) METHOD AND APPARATUS FOR INCREASING THE STOPPING ACCURACY OF A MOVING OBJECT

(75) Inventors: Ulrich Bock, Braunschweig (DE); Bernhard Evers, Braunschweig (DE); Uwe Kaluscha, Helmstedt (DE); Jürgen Radloff, Beedenbostel (DE); Karsten Rahn, Cremlingen (DE); Olaf Richter, Berlin (DE); Lars Schneider, Braunschweig (DE)

(73) Assignee: SIEMENS AKTIENGESELLSCHAFT, MÜNCHEN (DE)

(21) Appl. No.: 13/122,306

(22) PCT Filed: Sep. 28, 2009
(86) PCT No.: PCT/EP09/62520

§ 371 Date: Apr. 1, 2011

(30) Foreign Application Priority Data
Oct. 9, 2008 (DE) 10 2008 050 764.4

(51) Int. Cl. G06F 19/00; H04Q 5/22; G05D 1/00

(52) U.S. Cl. 701/70; 340/10.1

(57) ABSTRACT

A method and a device increase the stopping accuracy of a moving object, in particular a rail vehicle, at a predetermined stopping point. An RFID (Radio Frequency Identification) signal generated at the stopping point is received by the object and is used as a guidance variable for approaching the stopping point.

The invention relates to a method and an apparatus for increasing the stopping accuracy of a moving object, in particular of a rail vehicle, at a predetermined stopping point.

The following description relates essentially to exactly approaching the optimum stopping point for a rail vehicle in a train station area, although the invention is not restricted to this specific application. In fact, a number of applications are feasible, in which any desired moving object is intended to be brought to rest at a specific stopping point, for example a material feed in a production process. In modern train systems, in particular those with large numbers of passengers and/or automatic train operation, that is to say with few or no train and platform personnel whatsoever, it has become normal practice to protect the passengers on the platform against the approaching train, by means of platform doors. For this purpose, a wall provided with doors is located at the platform edge. Dangers resulting from the approaching train and stresses on the passengers caused by the resultant air flow, noise, etc., can in this way be precluded or reduced. Furthermore, this results in the capability to provide air conditioning in the stopping point area. Once the approaching train has come to rest exactly in front of the platform doors, the platform doors are opened together with the vehicle doors, and are closed again before the train departs. The stopping accuracy of the train is of major importance in this case.

Furthermore, problems occur in the event of defective platform doors and/or vehicle doors. This is because, with solutions which have been adopted so far, a platform door is opened even if the opposite vehicle door is defective, and the vehicle door is opened even when the opposite platform door is defective. In both cases, it is feasible for people to enter the danger area between the train and the platform doors, and this can lead to accidents.

It must also be remembered that trains of different train lengths are normally used. When a short train enters, only some of the platform doors must accordingly be operated, in order to open them.

The stopping accuracy at the platform is normally increased by transmission devices on the platform side, which act at a point. These are used as position reference points, with the rail vehicle positioning itself relative to them. These position reference points must be defined with very high precision. However, it may not always be possible to ensure the required precision, because of the local circumstances. Furthermore, if the rail vehicle finds its own position by means of trackside position reference points, for example beacons, beacon identification difficulties can occur because of accumulated positioning inaccuracies—drift. If an expected beacon has not been found in the supposedly expected window, the vehicle no longer has automatic braking curve monitoring and the locomotive engineer has to control the vehicle manually for the correct stopping point.

The invention is based on the object of specifying a method and an apparatus which allow the stopping point to be approached precisely. A further aim is for a simple capability to coordinate available vehicle and platform doors.

According to the method, the object is achieved in that an RFID (Radio-Frequency Identification) signal which is produced at the stopping point end is received at the object end, and is used as a reference variable for approaching the stopping point.

An apparatus for carrying out the method as claimed in claim 4, for this purpose has an RFID transponder which is associated with the stopping point and an RFID reader which is associated with the object, as well as means for determining a braking curve as a function of the receiving RFID signal.

The RFID reader is installed at the vehicle end on a rail vehicle, with the received information being passed on to a vehicle appliance for evaluation. The RFID transponder associated with the stopping point continuously produces an RFID signal, whose propagation time to the rail vehicle is used as a reference variable for the approach to the intended stopping point. The vehicle appliance calculates and monitors the determined braking curve on the basis of distance-specific and speed-specific RFID information, with high-precision, high-availability and reliability calculation principles being available, in contrast to conventional beacon positioning. The RFID signal is sent continuously and wirelessly in the form of a short-range electromagnetic radio-frequency field, in which case the reader can also be supplied with power. A very precise distance equivalent can be produced from the propagation time of the RFID signal, while the relative speed is obtained from the frequency shift resulting from the Doppler effect.

In addition to increasing the stopping accuracy, a further advantage over conventional systems is the capability to retrofit vehicles and platform stopping points easily.

According to claim 2, the RFID signal received by a rail vehicle is used, after reaching the stopping point, in order to produce an opening command for vehicle doors and/or platform doors. The increased stopping accuracy allows direct door operation without the interposition of further checking routines, for example of a visual nature.

In order to further increase safety at the platform, claim 3 additional provides that the RFID signal which is produced at the stopping point end comprises platform door availability data and is used at the vehicle end for selectively opening the vehicle doors, and in that an RFID signal which is produced at the rail vehicle end and comprises vehicle door availability data and train length data is received at the stopping point end and is used for selectively opening the platform doors.

According to claim 5, an apparatus is provided in which the RFID transponder at the stopping point end is designed to transmit platform door availability data to a vehicle door control device and in that an RFID transponder at the vehicle end is designed to transmit vehicle door availability data and train length data to a platform door control device.

The following functions are carried out at the vehicle end:
Reading the state data of the individual vehicle doors—intact/defective—from the vehicle door control device to the RFID transponder in the vehicle,
Reading the train length from train data from a train protection system or operator input into the RFID transponder of the vehicle,
Transmission of the RFID signal to the stopping point,
Reception of the RFID signal produced at the stopping point end, with state data for the platform doors—intact/defective—and
Generation of a command for selectively opening the vehicle doors on the basis of the received state data relating to the individual platform doors.

The following functions are carried out at the stopping point end:
Reading the state data of the individual vehicle doors—intact/defective—from the platform door control device to the RFID transponder at the stopping point,
Transmission of the RFID signal to the vehicle,
Reception of the RFID signal produced at the vehicle end with train length data and state data of the vehicle doors—intact/defective—and
Generation of a command for selectively opening the platform doors on the basis of the received train length data and state data of the individual vehicle doors.

Improved safety in the stopping point area is obtained by this reciprocal and door-selective platform door/vehicle door control, since no passengers can enter the danger area between the platform door and the vehicle door, or can enter the track area in the case of short trains.

The system can be integrated as an additional module in existing systems. It is therefore used as a reversionary level for existing train protection systems with continuous bidirectional data transmission. If the original data transmission channel is not available, then the selective door enabling can alternatively be carried out by the RFID transmission channel described above. There is therefore no need for the platform doors to be opened manually by the vehicle engineer operating a pushbutton.

However, the system can also be used as a stand-alone system, particularly when the aim is to use platform doors when no highly automated train protection system is available. In this case, there is likewise no need for the vehicle engineer to use a pushbutton for operation.

Furthermore, an interface on the track side can be designed for diagnosis systems, in which case both state data relating to the vehicle doors and state data relating to the platform doors can be transmitted to central diagnosis facilities.

The invention will be explained in the following text with reference to exemplary embodiments which are illustrated in the figures, in which:

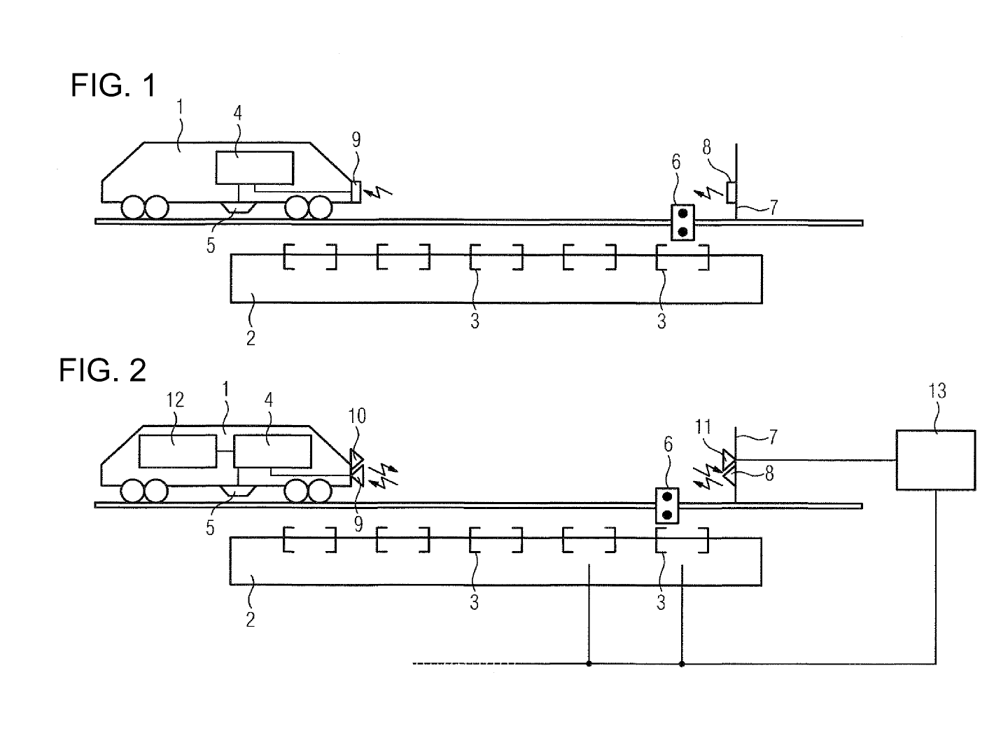

FIG. 1 shows a system for increasing the stopping accuracy, and

FIG. 2 shows a system for selective door opening.

FIG. 1 shows a rail vehicle 1 which is entering a platform 2 with platform doors 3. The rail vehicle 1 is normally equipped with a vehicle appliance 4 which interacts with trackside beacons 6 via a beacon antenna 5. The beacon information is read by the beacon antenna 5 as it passes by, and is evaluated by the vehicle appliance 4, for example in order to determine a braking curve. This function is dependent on the beacon 6 being expected, and therefore identified at all. In order to ensure that the rail vehicle 1 comes to rest exactly at a predetermined stopping point 7, the beacon 6 must also be positioned extremely accurately. However, the positioning of the beacon 6 is highly dependent on local circumstances, in particular the track bed conditions, as a result of which the achievable stopping accuracy is in some circumstances not sufficient for the vehicle doors and platform doors 3 to be aligned with one another. The locomotive engineer must then manually intervene in the automatic braking process. In the case of unmanned systems, additional complex technical systems are required to correct the stopping position. In order to make it possible to dispense with such additional systems and, where appropriate, to avoid the need for action by the locomotive engineer as well, an RFID system is provided. An RFID transponder 8 is arranged at the stopping point 7, with the electromagnetic radio-frequency field, which is emitted continuously by the RFID transponder 8, being identified by an RFID reader 9 on the rail vehicle 1 as it approaches the stopping point 7. This RFID system uses propagation time measurement to determine position and speed with high accuracy. In consequence, the remaining distance to the stopping point 7 is known. The received RFID signal is passed on to the vehicle appliance 4, where it is used to calculate and monitor an optimum braking curve as a function of the instantaneous speed.

FIG. 2 illustrates a configuration which is additionally designed to selectively open the platform doors 3 and—not illustrated—vehicle doors. For this purpose, as an extension to FIG. 1, bidirectional RFID signal transmission is provided between the rail vehicle 1 and the stopping point 7. The rail vehicle 1 is also equipped with an RFID transponder 10, which interacts with an RFID reader 11 at the stopping point end. Vehicle door availability data and train length data produced by a vehicle door control device 12 are transmitted via this data link to a platform door control device 13 at the stopping point end. For example, when a short train enters or a vehicle door is defective and cannot be opened, the platform door control device 13 also does not open the platform door associated with this alignment. Analogously, platform door availability data is transmitted to the vehicle door control device 12 with the aid of the RFID signal in the opposite direction, that is to say from the stopping point 7 to the rail vehicle 1, ensuring that the only vehicle doors which are opened at the stopping point 7 are those which are associated with serviceable platform doors 3.

As a modification to the described embodiment, the RFID reader 11 and the RFID transponder 8 at the stopping point end can be arranged at a distance from the stopping point 7. This always results in unambiguous range measurement, even for the situation when the stopping point 7 is driven over.

1-5. (canceled)

6. A method for increasing a stopping accuracy of a moving object at a predetermined stopping point, the method which comprises:
receiving at the moving object an RFID (Radio-Frequency Identification) signal produced at a side of a stopping point; and
using the RFID signal as a reference variable for approaching the stopping point.

7. The method according to claim 6 configured for improving the stopping accuracy of a rail vehicle.

8. The method according to claim 7, receiving the RFID signal by the rail vehicle and generating an opening command for vehicle doors and/or platform doors upon reaching the stopping point.

9. The method according to claim 7, which comprises:
using the RFID signal produced at the stopping point end and comprising platform door availability data at the rail vehicle for selectively opening the vehicle doors; and
receiving an RFID signal produced at the rail vehicle end and comprising vehicle door availability data and train length data at the stopping point and using the signal for selectively opening the platform doors.

10. An apparatus for carrying out the method according to claim 6, comprising:
an RFID transponder associated with the stopping point and an RFID reader associated with the object; and
a device for determining a braking curve as a function of the received RFID signal.

11. The method according to claim 10, wherein:
said RFID transponder associated with the stopping point is configured to transmit platform door availability data to a vehicle door control device; and
said RFID transponder associated with the vehicle is configured to transmit vehicle door availability data and train length data to a platform door control device.
